(19) United States
(12) Patent Application Publication
(10) Pub. No.: US 2026/0075394 A1
(43) Pub. Date: Mar. 12, 2026

(54) SERVICE FUNCTION CHAINING SYSTEM AND METHOD FOR MOBILE NETWORK

(71) Applicant: FOUNDATION OF SOONGSIL UNIVERSITY-INDUSTRY COOPERATION, Seoul (KR)

(72) Inventor: Young Han KIM, Seoul (KR)

(73) Assignee: FOUNDATION OF SOONGSIL UNIVERSITY-INDUSTRY COOPERATION, Seoul (KR)

(21) Appl. No.: 18/978,332

(22) Filed: Dec. 12, 2024

(30) Foreign Application Priority Data
Sep. 11, 2024 (KR) 10-2024-0124033

(51) Int. Cl. H04W 4/50

(52) U.S. Cl. CPC H04W 4/50

(57) ABSTRACT

A service function chaining device, system, and method for a mobile network. A service function chaining (SFC) apparatus located in a control plane comprises a processor; and a memory connected to the processor, wherein the memory stores program instructions, executed by the processor, to perform operations comprising receiving session information for a service from a mobile network, determining a service path for a plurality of service functions for service chaining on a data plane, and transforming and processing the session information and the service path into segment routing information and provisioning it to a classifier ingress located in a data plane and a forwarding/egress connected to an individual multi-access edge computing (MEC) hosting a service.

### TECHNICAL FIELD

The present invention relates to a service function chaining apparatus, system, and method for a mobile network.

### BACKGROUND ART

As mobile networks evolve to accommodate diverse services, efficient and flexible service provisioning mechanisms are required.

Service function chaining (SFC) provides a solution that enables dynamic chaining of multiple services hosted on multi-access edge computing (MEC) to process traffic in a specified order.

However, no study has provided a design for an SFC controller for mobile networks.

### DISCLOSURE

### Technical Issues

In order to solve the problems of the above-mentioned prior art, the present invention proposes a service function chaining apparatus, system and method for a mobile network that can improve the scalability and efficiency of mobile network operation by integrating SFC with a mobile user plane (MUP) architecture and utilizing segment routing (SR).

### Technical Solution

In order to achieve the above object, according to one embodiment of the present invention, a service function chaining (SFC) apparatus located in a control plane comprises a processor; and a memory connected to the processor, wherein the memory stores program instructions, executed by the processor, to perform operations comprising receiving session information for a service from a mobile network, determining a service path for a plurality of service functions for service chaining on a data plane, and transforming and processing the session information and the service path into segment routing information and provisioning it to a classifier ingress located in a data plane and a forwarding/egress connected to an individual multi-access edge computing (MEC) hosting a service.

The session information may comprise a UE (User Equipment) IP address, a UPF (User Plane Function) TEID (Tunnel ID) and a RAN (Radio Access Network).

The program instructions may perform segment routing information transformation processing in different ways in an NSH (network service header)-based SFC with an SRv6 transport tunnel, an SRv6-based SFC with an integrated NSH service plane, and an SR-based SFC.

The program instructions, after selecting a service path for a plurality of service functions for the service chaining, may query NSH-to-service mapping information and service locator mapping information regarding the plurality of service functions.

The NSH-to-service mapping information may be mapping information between an SPI (Service Path Identifier) and an SI (Service Index), and a service, and the service locator mapping information is information of each service, an IP address and transport encapsulation mapping.

The program instructions may generate Type 1 and Type 3 routing information using the session information, the service path, the NSH-to-service mapping information and the service locator mapping information for the NSH-based SFC with the SRv6 transport tunnel, and the Type 1 routing information may be provisioned only to the forwarding/egress, and the Type 3 routing information may be provisioned to both the classifier ingress and the forwarding/egress.

The Type 1 routing information comprises an N3 RAN address/prefix, an N3 TEID, a UE address/prefix, and the Type 3 routing information may comprise a plurality of MEC information hosting a service, NSH information, NSH-to-service mapping information, service locator mapping information, service chaining IP, N6 TEID, and N3 UPF address/prefix.

The program instructions may generate Type 1 and Type 4 routing information using the session information, the service path, the NSH-to-service mapping information, and the service locator mapping information for the SRv6-based SFC with the integrated NSH service plane, and the Type 1 routing information may be provisioned only to the forwarding/egress, and the Type 4 routing information is provisioned to both the classifier ingress and the forwarding/egress.

The Type 1 routing information comprises N3 RAN address/prefix, N3 TEID, UE address/prefix, and the Type 4 routing information may comprise a plurality of MEC information hosting service, a service address (service order list) required for data plane flow, NSH information, NSH-to-service mapping information, service locator mapping information, service chaining IP, N6 TEID, and N3 UPF address/prefix.

The program instructions may generate Type 5 routing information provisioned only to the classifier ingress and Type 1 routing information provisioned only to the forwarding/egress by using the session information, the service path, the NSH-to-service mapping information, and the service locator mapping information for the SR-based SFC.

The Type 1 routing information comprises N3 RAN address/prefix, N3 TEID, UE address/prefix, and the Type 5 routing information may comprise a plurality of MEC information hosting service, a service address (Service Order List) required for a data plane flow, a service chaining IP, N6 TEID, and N3 UPF address/prefix.

According to another aspect of the present invention, a service function chaining (SFC) system located in a control plane comprises a service chaining path resolution system that receives session information for a service from a mobile network and determines a service path for a plurality of service functions for service chaining on a data plane; and a session-transformed route system that transforms the session information and the service path into segment routing information and provisions it to a classifier ingress located in the data plane and a forwarding/egress connected to an individual multi-access edge computing (MEC) hosting a service.

According to another aspect of the present invention, a method for performing service function chaining (SFC) in an apparatus including a processor and a memory and located in a control plane comprises receiving session information for a service from a mobile network; determining a service path for a plurality of service functions for service chaining on a data plane; and transforming the session information and the service path into segment routing information and provisioning it to a classifier ingress located in a data plane and a forwarding/egress connected to an individual MEC (Multi-access Edge Computing) hosting a service.

According to another aspect of the present invention, a user terminal for service function chaining (SFC) comprises a wireless transceiver for transmitting and receiving a wireless signal; a memory for storing program instructions; and a processor for executing the program instructions and controlling the transceiver, wherein the processor controls the wireless transceiver, so that a service function chaining (SFC) apparatus located in the control plane receives session information for a service from a mobile network, determines a service path for a plurality of service functions for service chaining, transforms and processes the session information and the service path into segment routing information, and provisions it to a classifier ingress located in a data plane and a forwarding/egress connected to an individual MEC (Multi-access Edge Computing) hosting a service, so that traffic is received through the classifier ingress and the gNB after completion of the plurality of service functions.

### ADVANTAGEOUS EFFECTS

According to the present invention, the MUP function can be improved to support both Stateful and Stateless SFC scenarios, which can solve the limitations of the existing MUP by integrating the controller responsible for session transformation path provisioning and service chain path verification.

In addition, according to the present invention, not only can the SFC path management be optimized in the SRv6-supporting mobile network, but also the routing process can be simplified to reduce the overhead and improve the network performance, and the efficient service coordination in the next-generation mobile network can be ensured to meet the increasing demand for providing high-quality and complex services.

### DESCRIPTION OF DRAWINGS

These and/or other aspects will become apparent and more readily appreciated from the following description of the embodiments, taken in conjunction with the accompanying drawings in which:

FIG. 1 is a diagram illustrating the architecture between components of SFC;

FIG. 2 is a diagram illustrating the MUP architecture for the distributed mobility management architecture;

FIG. 3 is a diagram illustrating a detailed description of an NSH-based SFC scenario with an SRv6 transport tunnel;

FIG. 4 is a diagram illustrating a detailed description of an SRv6-based SFC scenario with an integrated NSH service plane;

FIG. 5 is a diagram illustrating a detailed description of an SRv6-based SFC scenario;

FIG. 6 is a diagram illustrating an SFC procedure according to the present embodiment;

FIG. 7 is a diagram schematically illustrating the configuration of an MUP-C for service function chaining according to the present embodiment;

FIG. 8 is a diagram illustrating a detailed configuration of an MUP-C for an NSH-based SFC with an SRv6 transport tunnel according to the present embodiment;

FIG. 9 is a diagram illustrating a detailed configuration of an MUP-C for an SRv6-based SFC with an integrated NSH service plane;

FIG. 10 is a diagram showing the detailed configuration of MUP-C for SR-based SFC according to the present embodiment; and

FIG. 11 is a diagram showing the detailed configuration of a user terminal according to the present embodiment.

### DETAILED DESCRIPTION OF EMBODIMENTS

The present invention can have various modifications and various embodiments, and specific embodiments are illustrated in the drawings and described in detail in the detailed description. However, this is not intended to limit the present invention to specific embodiments, and it should be understood that it includes all modifications, equivalents, and substitutes included in the spirit and technical scope of the present invention.

The terms used in this specification are used only to describe specific embodiments, and are not intended to limit the present invention. The singular expression includes the plural expression unless the context clearly indicates otherwise. In this specification, the terms “comprises” or “has” and the like are intended to specify the presence of a feature, number, step, operation, component, part, or combination thereof described in the specification, and should be understood not to exclude in advance the possibility of the presence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope that the technical idea of the present invention is maintained, and it is also obvious that multiple embodiments may be re-implemented as one embodiment integrated even if a separate description is omitted.

In addition, when describing with reference to the attached drawings, the same components are given the same or related reference numerals regardless of the drawing numerals, and redundant descriptions thereof are omitted. In describing the present invention, if it is determined that a specific description of a related known technology may unnecessarily obscure the gist of the present invention, a detailed description thereof is omitted.

In this embodiment, a novel method is provided to improve the scalability and efficiency of mobile network operation by integrating SFC with MUP architecture and utilizing segment routing.

In particular, this embodiment can manage and distribute routing information through an improved controller to ensure smooth service delivery throughout the network. In this embodiment, three unique service function chaining scenarios are described: NSH (Network Service Header)-based SFC with SRv6 transport tunnel, SRv6-based SFC with integrated NSH service plane, and SR-based SFC.

In the following, the MUP architecture for SFC and distributed mobility management is described first, and then the service function chaining scenario is described according to this embodiment in detail.

An SFC is generated to support the provision of a composite service that requires a set of service functions, and as a result, it is a set of abstract service functions and service ordering constraints that should be applied to packets and selected flows.

The components of SFC comprise a classifier (CF) ingress, a service function forwarder (SFF), an SFC proxy, and a service function (SF).

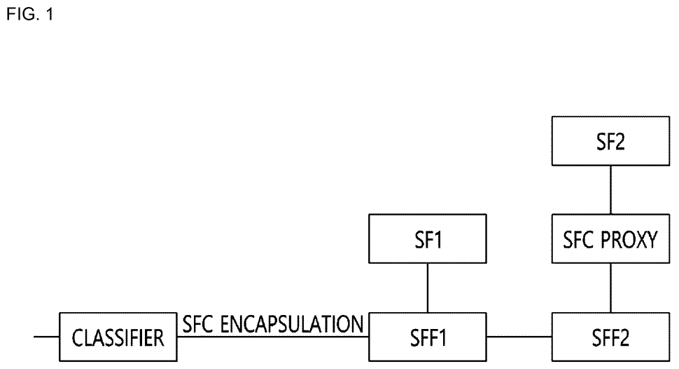

FIG. 1 is a diagram illustrating the architecture between components of SFC.

The classifier ingress classifies traffic by adding a relevant network service header (NSH) to packets.

The SFF routes traffic to an SF on a predefined routing path.

SF is an actual service such as a firewall or deep packet inspection, and when extended to the cloud, SF can become various application services such as image processing, speech recognition, and AI services.

If SF cannot process NSH, SFC proxy is used.

Since this embodiment relates to a service function chaining method for SR-based mobile networks, the following describes an MUP architecture using SR architecture for distributed mobility management.

The MUP using SR architecture is used to enable the SR data plane to integrate MUP in IP networks.

IPv6, which has a large address space available for SR to cover a large number of nodes, possibly millions of base stations, is suitable for the IP connectivity requirements of mobile services. MUP using SRv6 can replace IP connectivity for both the N3 interface (interface between gNB and UPF) and the N6 interface (interface between UPF and data network).

The MUP architecture mainly comprises a controller for the SR network (MUP-controller) and a MUP aware provider edge (MUP-PE).

The MUP-PE may comprise ingress and forwarding/egress.

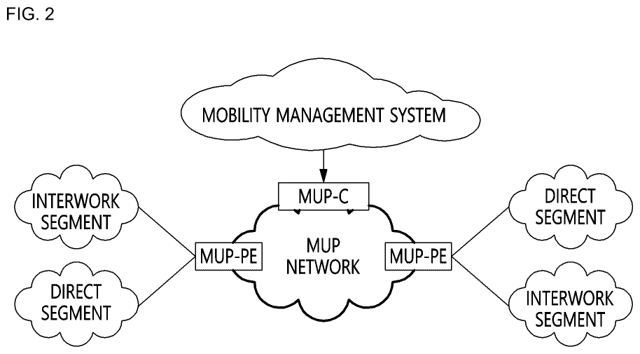

FIG. 2 is a diagram illustrating the MUP architecture for distributed mobility management architecture.

As illustrated in FIG. 2, the MUP-C transforms the session information received from the mobility management system (MMS) into routing information and then advertises the session-transformed route to the SR domain.

The approach is that the traffic sent by the user can be directly routed to the service instance through the SR underlay network.

There are three main principles in the MUP architecture.

The first is the abstraction of the MUP. A MUP segment is used to represent a network segment that contains a mobile service.

An MUP-PE can accommodate MUP segments such as an Interwork Segment (providing connectivity between other MUP segments via the user plane protocols of the mobile service architecture and the MUP network) and/or a Direct Segment (providing connectivity between MUP segments via the MUP network).

The second is auto-discovery for MUP segments. An MUP-PE should be able to discover MUP segments from remote MUP-PEs, and remote MUP-PEs should advertise auto-discovery paths to hosted MUP segments. An MUP-PE can discover MUP segments from a remote MUP-PE only if it can find MUP segment information in the received auto-discovery path.

The last principle is the role of MUP-C, which transforms session information into segment routing information.

The following describes the service function chaining data plane.

The types of service chains may include stateful and stateless service chains.

The stateful service chain application discussed in RFC 9491 presents two scenarios of NSH and segment routing integration: Segment Routing-Multi-Protocol Label Switching (SR-MPLS) or NSH-based SFC with SRv6 transport tunnels and SRv6-based SFC with integrated NSH service planes.

Stateless service chains are discussed as configuring the service chain architecture based on pure SRv6 headers.

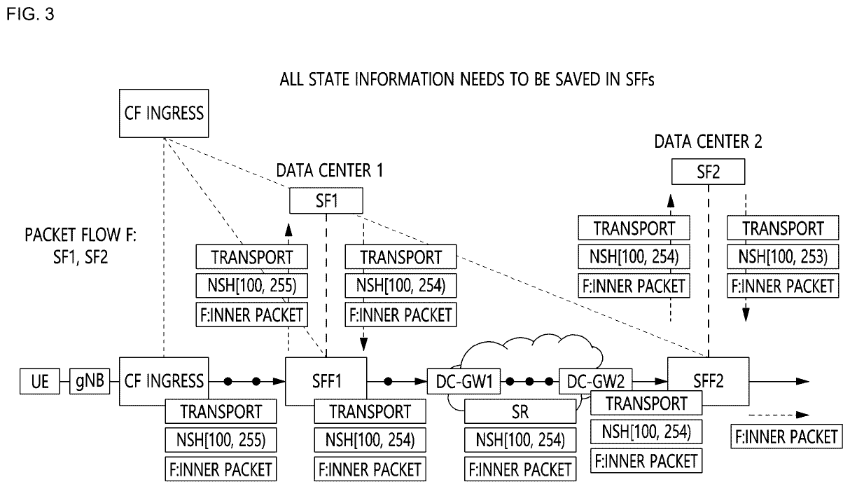

FIG. 3 is a diagram illustrating a detailed description of the NSH-based SFC scenario with SRv6 transport tunnels.

In the NSH-based SFC scenario, SR-MPLS or SRv6 considers NSH header transmission between SFFs.

Starting from Packet Flow F containing SF1 of Data Center 1 (DC1) and SF2 of Data Center 2 (DC2), the incoming traffic (i.e., inner packets) classified at the classifier ingress is encapsulated in the routing header as Transport-NSH-Inner Packet.

The SFF1 node uses the Service Path Identifier (SPI) and Service Index (SI) encapsulated in the NSH to determine whether the packet should be forwarded to SF1.

SF1 executes the specified service, decrements the SI by 1, and returns the packet to SFF1.

Upon re-entry to SFF1, the packet is marked as <SPI 100, SI 254>. SFF1 performs a lookup on this tuple and decides to forward the packet to the next hop, DC1-GW1.

At DC1-GW1, the system performs a lookup using the NSH-provided information and decides to forward the packet to DC2-GW2 using the specified encapsulated SR header.

The encapsulated SR header contains a list of segments that guide the packet through the inter-datacenter network towards DC2.

Upon arrival at DC2, the SR capsule is removed and DC2-GW2 performs a lookup in the NSH to create a next hop to SFF2. When received by SFF2, a lookup is performed for <NSH: SPI 100, SI 254>and it decides to forward the packet to SF2. SF2 then applies the service, decrements SI by 1, and sends the packet back to SFF2. When the packet returns to SFF2, it now owns <NSH: SPI 100, SI 253>. SFF2 performs a lookup for the tuple indicating the end point of the chain.

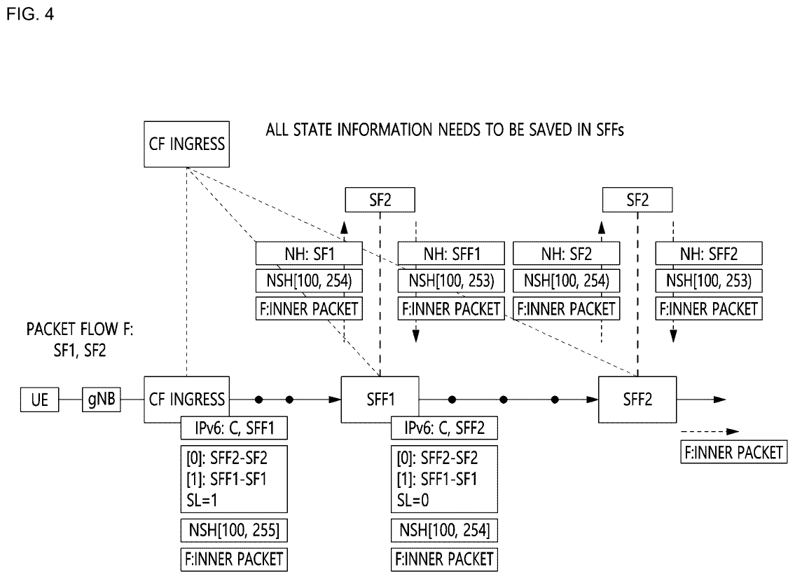

FIG. 4 is a diagram illustrating a detailed description of an SRv6-based SFC scenario with a unified NSH service plane.

Referring to FIG. 4, in this scenario, the address of the SF is encapsulated directly in the SR header as a SID (segment identifier), and the NSH tag is used to identify the service plane and service chain that the SF can handle the service chain traffic.

When the SFC is established, packets passing through the service chain are initially tagged with the NSH tag.

NSH is required to preserve the end-to-end service plane by utilizing the SFC context.

The SFC context plays an important role in allowing the SFF to identify the list of SR segments required to route the packet to the subsequent SFF in the chain. The packet is then encapsulated in the SR header and forwarded within the SR domain in compliance with the standard operation of segment routing.

When a packet needs to be forwarded to a service function connected to the SFF, the SFF performs a lookup using the SID corresponding to the SF. The result of this lookup allows the SFF to identify the next-hop context between the SFF and the SF, such as the MAC address when Ethernet encapsulation is used. Then, SFF removes SR information from encapsulated packets, updates SR details, and stores this updated information in the cache. The cache is indexed by SPI and SI, and SI is decremented by 1. This cached SR information is later used to re-encapsulate and forward packets returned from SF.

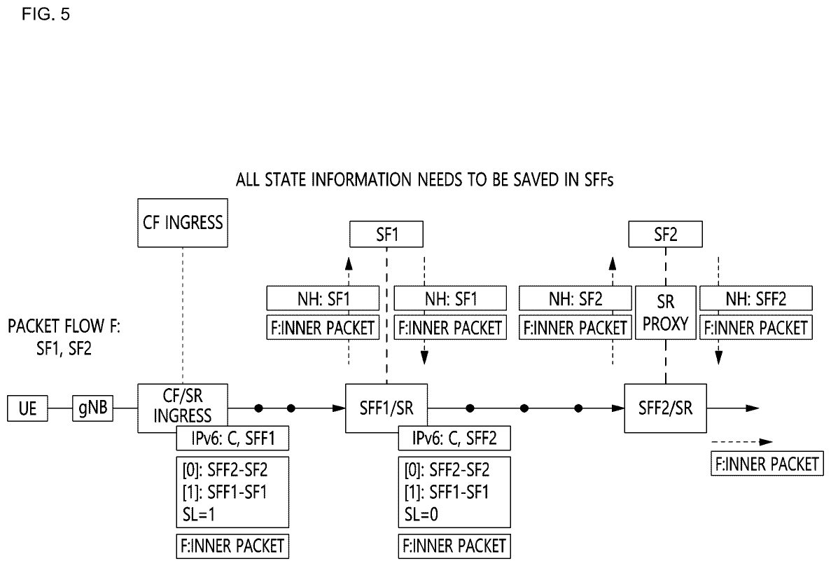

FIG. 5 is a diagram illustrating a detailed description of an Srv6-based SFC scenario.

Referring to FIG. 5, in this scenario, NSH usage is removed from the SR header, which reduces the state information stored in SFF. This information is stored only in classifier ingress, thus reducing overhead.

However, an SR proxy is required for SFs that do not recognize the SR header.

In SFF and SF management within the SRv6 underlay network, each SFF and SF is assigned a specific SRv6 SID to facilitate NSH-independent service chain path configuration.

In this context, a service chain path is represented by a sequence of SRv6 SIDs carried within the Segment Routing Header (SRH). The SR proxy performs several important tasks to ensure packet delivery, such as removing and temporarily storing SRH before forwarding the inner packet to the SF that is unaware of SR, and restoring SRH to the inner packet after receiving it again from the SF.

The following describes the architecture of service function chaining for mobile networks according to this embodiment in detail.

In general, MUP architectures focus only on standalone services and overlook the concept of SFC. A new approach to service function chaining that coordinates multiple services to fulfill user requests is needed.

In this context, this embodiment proposes an improved service function chain MUP controller, focusing on packet design and service chain path selection in SRv6 MUP networks.

The MUP controller according to this embodiment is proposed to adopt various SFC application scenarios, namely, Stateful and Stateless SFC.

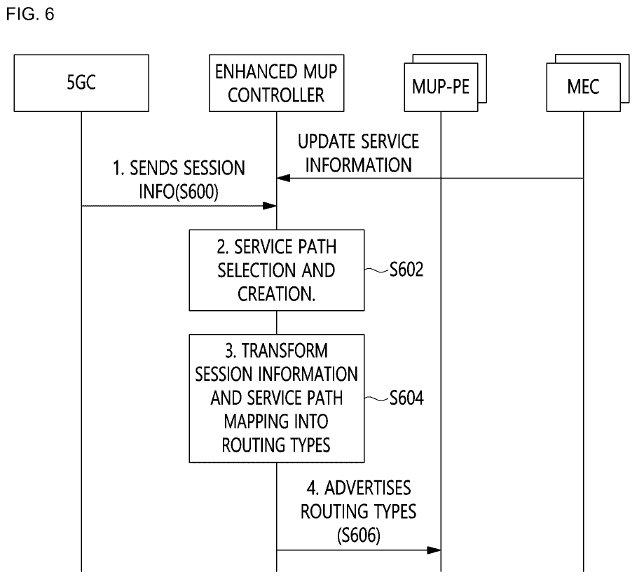

FIG. 6 is a diagram illustrating an SFC procedure according to the present embodiment.

Referring to FIG. 6, when a core of a mobile network (e.g., an SMF of 5GC) receives a service request from a UE (User Equipment), it transmits the mobile session information of the UE to the MUP controller according to the present embodiment (step 600).

The MUP controller according to the present embodiment may be defined as a Computing-Aware Traffic Steering (CATS)-based MUP controller (CATS-MUP-C).

The CATS framework is used to select a suitable service instance from a set of available service contact instances through networking and computing metrics.

The idea of CATS is that the resources of a service site hosting a service instance are limited and the availability of those resources varies over time.

Therefore, in general, it can help to provide service instances that are appropriate for the traffic rather than depending on the geographic location of the instance when considering networking and computing resource metrics.

The CATS framework includes main functional components such as CATS-Forwarder, CATS Path Selector (C-PS), CATS Service Metric Agent (C-SMA), CATS Network Metric Agent (C-NMA), and CATS Traffic Classifier (C-TC).

In order to generate a routing path in the MUP-C according to the present embodiment, the mobile session information should include parameters such as a service function chaining IP address, a UE IP address, a UPF TEID, and a RAN TEID.

After receiving the mobile session information including the chained service identification information, the MUP-C according to the present embodiment selects a service path for multiple service functions (step 602).

According to the present embodiment, the session information may comprise a service chaining IP. The service chaining IP may be defined as an IP specified among the AnyCast IPs to recognize that the service requested by the user is a service having chaining.

After verifying the session information and service path, the MUP-C according to the present embodiment processes the routing information transformation for the SRv6 underlay network (step 604).

The proposed routing type in the SRv6 context is used according to the application scenario of Stateful or Stateless SFC, and Type 1 routing information is generated using the necessary information from the session information.

The MUP-C according to the present embodiment advertises the routing information to the corresponding MUP-PE that establishes the routing connection for the UE (step 606).

The data plane of the SFC has been discussed in various ways in the past, but the controller design has not been specifically proposed.

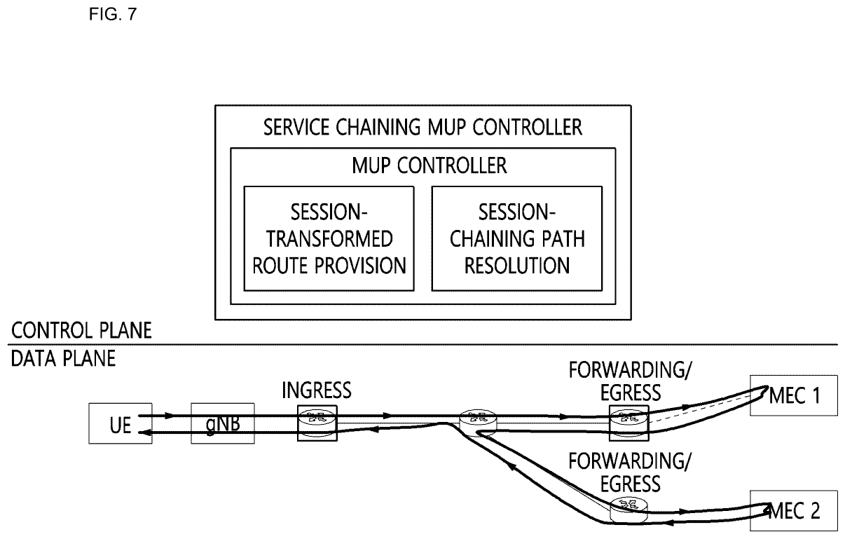

FIG. 7 is a diagram schematically illustrating the configuration of the MUP-C for service function chaining according to the present embodiment.

As illustrated in FIG. 7, the MUP-C according to the present embodiment is responsible for the session-transformed route provisioning function and the service chaining path resolution.

In the data plane of SFC for mobile networks, traffic that is sequentially processed by MEC 1 and MEC 2 and then retransmitted to the UE is required.

As a result, the MUP-C according to the present embodiment should provide both forward and reverse route information.

The various improvements of the MUP-C according to the present embodiment for various SFC scenarios are to perform routing information transformation processing according to various types of session information. In the present embodiment, three types of routing information transformation processing for the SFC scenario are proposed.

In more detail, the types proposed in the present embodiment are defined as Type 3, Type 4, and Type 5, each of which is defined as different routing information transformation processing in NSH-based SFC with SRv6 transport tunnel, SRv6-based SFC with integrated NSH service plane, and SR-based SFC.

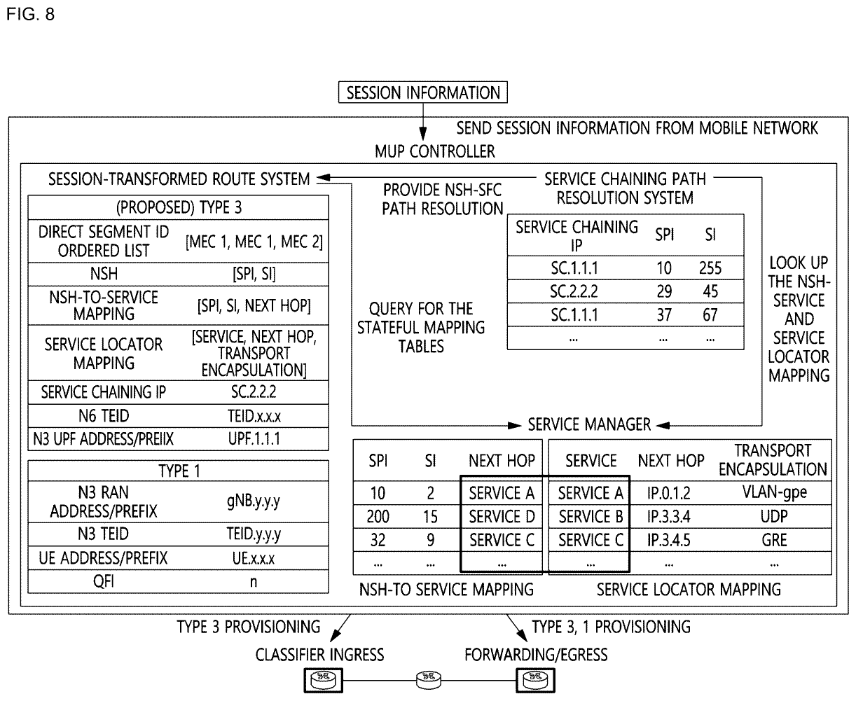

FIG. 8 is a diagram illustrating a detailed configuration of the MUP-C for NSH-based SFC with SRv6 transport tunnel according to the present embodiment.

Referring to FIG. 8, the MUP-C for Type 3 according to the present embodiment may comprise a service chaining path resolution system 800, a service manager 802, and a session-transformed route system 804.

The service chaining path resolution system 800 determines the service and service order for service chaining after receiving session information for a given service from a mobile network, and queries the NSH-to-service mapping information and the service locator mapping information regarding the identified service in the service manager 802.

The NSH-to-service mapping is the mapping information between the SPI and SI, and the service, and the service locator mapping is the mapping information of each service and the IP address and transport encapsulation. Here, the transport encapsulation is distinguished according to the communication protocol.

The service chaining path resolution system 800 provides the SFC path information determined through the above query to the session-transformed route system 804.

The session-transformed route system 804 queries the service manager 802 for the stateful mapping information delivered to the routing type.

The session-transformed route system 804 generates routing types for Type 1, which processes basic session data such as TEID and UE address, and Type 3, which includes Direct Segment ID Order List (MEC information hosting the service), NSH information, NSH-to-service mapping information, service locator mapping information, service chaining IP address, N6 TEID, and N3 UPF address/prefix.

The session information, NSH mapping, and stateful state are encoded into the routing type. As shown in FIG. 8, the session-transformed route system 804 provides two encoded routing types to one or more nodes.

Type 3 is provisioned to all nodes, i.e., classifier ingress and forwarding/egress, due to the stateful state required for NSH header routing, while Type 1 is provisioned only to the last node, i.e., forwarding/egress, which is used to reroute traffic to the user.

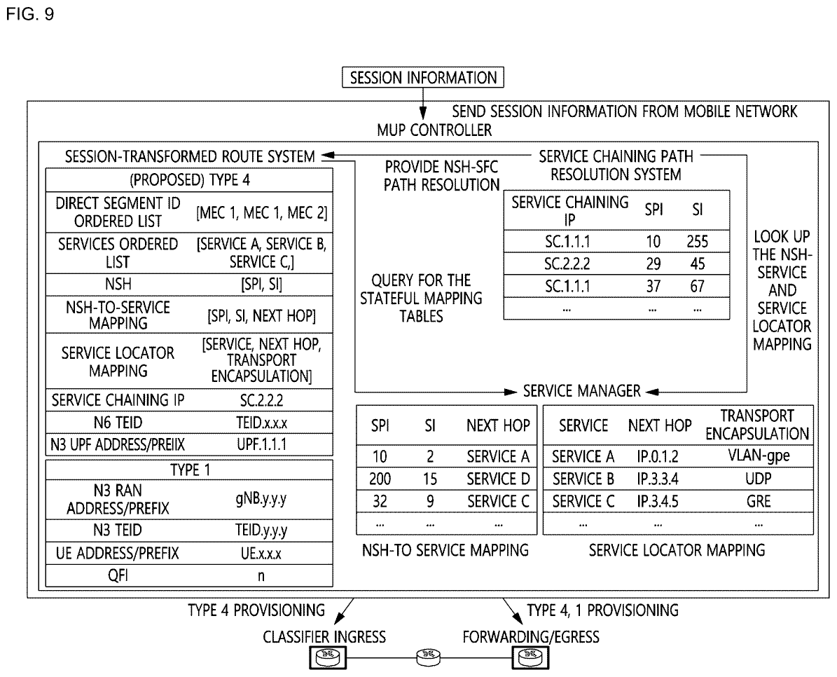

FIG. 9 is a diagram illustrating a detailed configuration of MUP-C for SRv6-based SFC with an integrated NSH service plane.

Referring to FIG. 9, the flow in the SRv6-based SFC scenario with an integrated NSH service plane is similar to the NSH-based SFC scenario with the SRv6 transport tunnel illustrated in FIG. 8.

However, Type 4 according to the present embodiment is proposed to include one more attribute called Service Order List, which is required for the data plane flow described in FIG. 4.

the service address is encapsulated with other attributes of Srv6 for traffic routing.

Type 4 according to the present embodiment is provisioned to all nodes due to the stateful state required for NSH header routing, while Type 1 is provisioned only to the last node used to reroute traffic to the user.

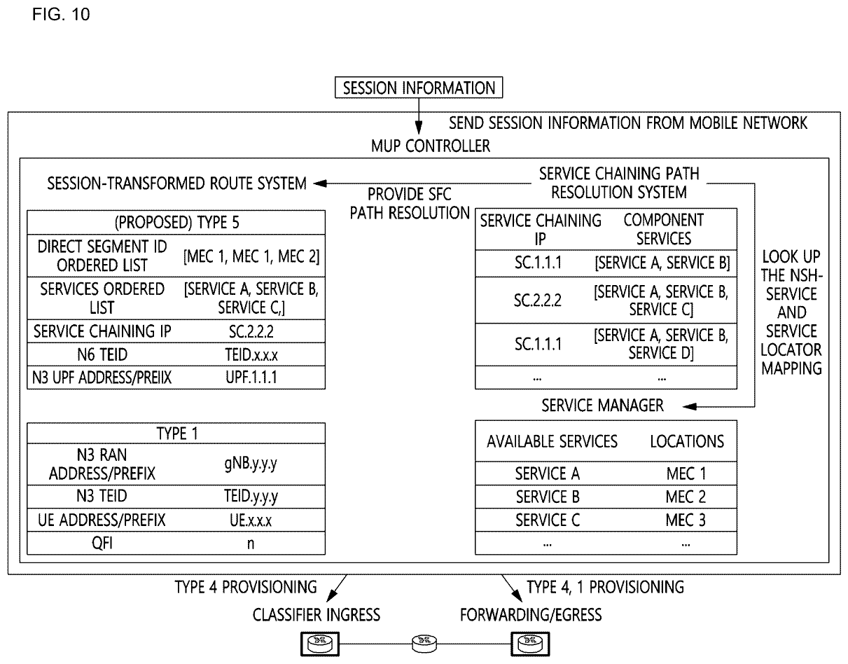

FIG. 10 is a diagram illustrating a detailed configuration of MUP-C for SR-based SFC according to the present embodiment.

Referring to FIG. 10, there is no stateful state distribution to nodes in the scenario. SRv6 is used only for SFC traffic. Classifier Ingress is responsible for encapsulating traffic flow in the data plane.

FIG. 10 shows a processing flow diagram starting from session information to the routing type provisioned to the corresponding node.

First, the session information is transmitted to the MUP-C according to the embodiment in the mobile network.

The service chaining path resolution system determines the service chaining path, and at this time, queries the service manager 802 for service locator mapping to form the service path.

Then, it provides the service path information to the session-transformed route system 804.

The session-transformed route system generates the routing type using the session information and the service path information.

The new routing Type 5 is proposed to convey less information than the stateful scenario, which only includes Direct Segment ID Ordered List, Services Ordered List, Service Chaining IP, and other attributes for routing mapping.

Type 5 is provided only to pass SFC mapping to classifier ingress, while Type 1 is the default type of MUP to process direct routing provided to forwarding/egress nodes (MUP-PE). As with stateful scenarios, Type 1 is used only for direct routing to maintain the integrity of the network.

The above-described service function chaining method for a mobile network may also be implemented in the form of a recording medium including computer-executable instructions, such as an application or program module executed by a computer. The computer-readable medium may be any available medium that can be accessed by a computer, and includes both volatile and nonvolatile media, removable and non-removable media. In addition, the computer-readable medium may include a computer storage medium. The computer storage medium includes both volatile and nonvolatile, removable and non-removable media implemented by any method or technology for storing information, such as computer-readable instructions, data structures, program modules, or other data.

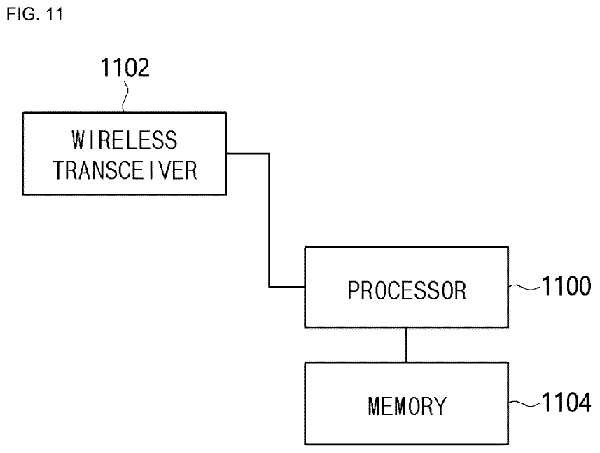

FIG. 11 is a drawing illustrating a detailed configuration of a user terminal according to the present embodiment.

Referring to FIG. 11, the user terminal according to the present embodiment may comprise a processor 1100, a wireless transceiver 1102, and a memory 1104.

Here, the processor 1100 may comprise a central processing unit (CPU) capable of executing a computer program or a virtual machine, etc.

The memory 1102 may include a nonvolatile storage device such as a fixed hard drive or a removable storage device. The removable storage device may include a compact flash unit, a USB memory stick, etc. The memory 1102 may also include a volatile memory such as various random access memories, and may be defined as a computer-readable recording medium.

The wireless transceiver 1102 transmits and receives wireless signals through one or more antennas under the control of the processor 1100.

The memory 1102 according to the present embodiment stores program instructions for providing service function chaining for a mobile network, and the processor 1100 executes the program instructions to transmit a PDU session establishment request signal regarding the chained service to the mobile network through the wireless transceiver 1102.

In addition, the processor 1100 controls the wireless transceiver 1102 so that the service function chaining (SFC) apparatus located in the control plane receives session information for a predetermined service from the mobile network, determines a service path for a plurality of service functions for service chaining, transforms the session information and the service path into segment routing information and provisions it to a forwarding/egress connected to a classifier ingress located in the data plane and an individual MEC (Multi-access Edge Computing) hosting the service, and receives traffic through the classifier ingress and the gNB after the completion of the plurality of service functions.

The above-described embodiments of the present invention are disclosed for the purpose of illustration, and those skilled in the art having common knowledge of the present invention will be able to make various modifications, changes, and additions within the spirit and scope of the present invention, and such modifications, changes, and additions should be considered to fall within the scope of the following patent claims.

1. A service function chaining (SFC) apparatus located in a control plane comprising:
a processor; and
a memory connected to the processor,
wherein the memory stores program instructions, executed by the processor, to perform operations comprising:
receiving session information for a service from a mobile network,
determining a service path for a plurality of service functions for service chaining on a data plane, and
transforming and processing the session information and the service path into segment routing information and provisioning it to a classifier ingress located in a data plane and a forwarding/egress connected to an individual multi-access edge computing (MEC) hosting service.

2. The apparatus of claim 1, wherein the session information comprises a UE (User Equipment) IP address, a UPF (User Plane Function) TEID (Tunnel ID) and a RAN (Radio Access Network).

3. The apparatus of claim 1, wherein the program instructions perform segment routing information transformation processing in different ways in an NSH (network service header)-based SFC with an SRv6 transport tunnel, an SRv6-based SFC with an integrated NSH service plane, and an SR-based SFC.

4. The apparatus of claim 3, wherein the program instructions, after selecting a service path for a plurality of service functions for the service chaining, query NSH-to-service mapping information and service locator mapping information regarding the plurality of service functions.

5. The apparatus of claim 4, wherein the NSH-to-service mapping information is mapping information between an SPI (Service Path Identifier) and an SI (Service Index), and a service, and the service locator mapping information is information of each service, an IP address and transport encapsulation mapping.

6. The apparatus of claim 5, wherein the program instructions generate Type 1 and Type 3 routing information using the session information, the service path, the NSH-to-service mapping information and the service locator mapping information for the NSH-based SFC with the SRv6 transport tunnel,
wherein the Type 1 routing information is provisioned only to the forwarding/egress, and the Type 3 routing information is provisioned to both the classifier ingress and the forwarding/egress.

7. The apparatus of claim 6, wherein the Type 1 routing information comprises an N3 RAN address/prefix, an N3 TEID, a UE address/prefix,
wherein the Type 3 routing information comprises a plurality of MEC information hosting a service, NSH information, NSH-to-service mapping information, service locator mapping information, service chaining IP, N6 TEID, and N3 UPF address/prefix.

8. The apparatus of claim 4, wherein the program instructions generate Type 1 and Type 4 routing information using the session information, the service path, the NSH-to-service mapping information, and the service locator mapping information for the SRv6-based SFC with the integrated NSH service plane,
wherein the Type 1 routing information is provisioned only to the forwarding/egress, and the Type 4 routing information is provisioned to both the classifier ingress and the forwarding/egress.

9. The apparatus of claim 8, wherein the Type 1 routing information comprises N3 RAN address/prefix, N3 TEID, UE address/prefix,
wherein the Type 4 routing information comprises a plurality of MEC information hosting service, a service address (service order list) required for data plane flow, NSH information, NSH-to-service mapping information, service locator mapping information, service chaining IP, N6 TEID, and N3 UPF address/prefix.

10. The apparatus of claim 4, wherein the program instructions generate Type 5 routing information provisioned only to the classifier ingress and Type 1 routing information provisioned only to the forwarding/egress by using the session information, the service path, the NSH-to-service mapping information, and the service locator mapping information for the SR-based SFC.

11. The apparatus of claim 10, wherein the Type 1 routing information comprises N3 RAN address/prefix, N3 TEID, UE address/prefix,
wherein the Type 5 routing information comprises a plurality of MEC information hosting service, a service address (Service Order List) required for a data plane flow, a service chaining IP, N6 TEID, and N3 UPF address/prefix.

12. A service function chaining (SFC) system located in a control plane comprising:
a service chaining path resolution system that receives session information for a service from a mobile network and determines a service path for a plurality of service functions for service chaining on a data plane; and
a session-transformed route system that transforms the session information and the service path into segment routing information and provisions it to a classifier ingress located in the data plane and a forwarding/egress connected to an individual multi-access edge computing (MEC) hosting a service.

13. The system of claim 12 further comprises,
a service manager that stores NSH-to-service mapping information and service locator mapping information regarding the plurality of service functions.

14. A method for performing service function chaining (SFC) in an apparatus including a processor and a memory, and located in a control plane comprising:
receiving session information for a service from a mobile network;
determining a service path for a plurality of service functions for service chaining on a data plane; and
transforming the session information and the service path into segment routing information and provisioning it to a classifier ingress located in a data plane and a forwarding/egress connected to an individual MEC (Multi-access Edge Computing) hosting a service.

15. The method of claim 14, wherein the provisioning performing segment routing information transformation processing in different ways in an NSH (Network Service Header)-based SFC with an SRv6 transport tunnel, an SRv6-based SFC with an integrated NSH service plane, and an SR-based SFC.

16. The method of claim 15, wherein the provisioning comprises,
querying, after selecting a service path for a plurality of service functions for the service chaining, NSH-to-service mapping information and service locator mapping information regarding the plurality of service functions.

17. The method of claim 16, wherein the NSH-to-service mapping information is mapping information between an SPI (Service Path Identifier) and an SI (Service Index), and a service, and the service locator mapping information is information of each service, an IP address and transport encapsulation.

18. A user terminal for service function chaining (SFC) comprising:
a wireless transceiver for transmitting and receiving a wireless signal;
a memory for storing program instructions; and
a processor for executing the program instructions and controlling the transceiver,
wherein the processor controls the wireless transceiver, so that a service function chaining (SFC) apparatus located in the control plane receives session information for a service from a mobile network, determines a service path for a plurality of service functions for service chaining, transforms and processes the session information and the service path into segment routing information, and provisions it to a classifier ingress located in a data plane and a forwarding/egress connected to an individual MEC (Multi-access Edge Computing) hosting a service, so that traffic is received through the classifier ingress and the gNB after completion of the plurality of service functions.
